(19) United States
(12) Patent Application Publication
(10) Pub. No.: US 2026/0103617 A1
(43) Pub. Date: Apr. 16, 2026

(54) Aqueous coating agent

(71) Applicant: Henkel AG & Co. KGaA, Düsseldorf (DE)

(72) Inventors: Chiho Sakoda, Osaka (JP); Yoshio Yoshida, Osaka (JP)

(21) Appl. No.: 19/419,347

(22) Filed: Dec. 15, 2025

Related U.S. Application Data
(63) Continuation of application No. PCT/JP2024/023534, filed on Jun. 28, 2024.

(30) Foreign Application Priority Data
Jun. 29, 2023 (JP) 2023-106958

(51) Int. Cl. C09D 123/08; C08K 3/12; C08K 3/22; C09D 7/61; C09D 7/65; D21H 19/12; D21H 19/20; D21H 19/34; D21H 19/82; D21H 21/16; D21H 27/10

(52) U.S. Cl. CPC C09D 123/0869; C08K 3/12; C08K 3/22; C09D 7/61; C09D 7/65; D21H 19/12; D21H 19/20; D21H 19/34; D21H 19/824; D21H 21/16; D21H 27/10

(57) ABSTRACT

Disclosed is an aqueous coating agent comprising: (A) a copolymer of ethylene with a carboxylic acid derivative having an ethylenic double bond; (B) a basic material; and (C) particles having melting point of 100° C. or more, and is further a paper substrate coated with the aqueous coating agent.

### TECHNICAL FIELD

The present invention relates to an aqueous coating agent with which a paper substrate is coated.

### BACKGROUND ART

A reduction of plastic products is recommended throughout the world in consideration of environmental problems. Such plastic products are incapable of naturally decomposing, and it is difficult to dispose of the plastic products. Moreover, burning of plastics may result in generation of dioxine and may cause air pollution. Further, in recent years, possibilities that plastic refuse is discarded in the sea and decomposes into microlevels to form small pieces of debris, fish in the sea eat the debris, and humans eat the fish have been perceived as problems. Given such a backdrop, the replacement of plastics with paper substrates has been examined, and particularly in a food field, paper substrates have been processed and made into containers.

Conventionally, laminated paper has been used as one form of a paper substrate. The laminated paper is subjected to treatment to prevent the strength of the paper from decreasing and a hand from being dirty due to bleeding an oil component derived from food, or the like.

In laminated paper, a polyethylene film or the like is commonly laminated on a paper substrate. In recent years, the recycling of laminated paper has been required due to the raising of environmental awareness. However, such a film has been a stumbling block, and a special device has been thus required for efficiently recycling laminated paper.

Patent Literatures 1 and 2 disclose that an aqueous dispersion of an ethylene-based resin is applied to paper.

Patent Literature 1 describes that an aqueous dispersion of an ethylene/acrylic acid copolymer, neutralized with ammonia or an amine is useful as a heat sealant for paper or aluminum foil (see [Claims], [0025], [0028], [0029], and [0044]).

Patent Literature 2 describes that an aqueous dispersion comprising an ethylene/ethyl acrylate copolymer subjected to acid modification and wax can be applied to a paper substrate (see [Claims], [0046], Table 1 in [0056], and Table 3 in [0068]).

### CITATION LIST

### Patent Literature

[Patent Literature 1] JP 2000-7860 A
[Patent Literature 2] JP 2006-45313 A

### SUMMARY OF INVENTION

### Technical Problem

Patent Literatures 1 and 2 disclose that the aqueous dispersions in Examples in both the literature (or coating films or coatings formed from the aqueous dispersions) are excellent in heat-sealing properties.

When a food packaging container is a common paper cup, an end section of the paper cup is formed by coating the end section with an aqueous coating agent and then heating the aqueous coating agent. Accordingly, the aqueous coating agent with which the end section of the paper cup is coated (or a coating film formed from the aqueous coating agent) requires heat-sealing properties. Further, the aqueous coating agent for a paper cup requires various performances as well as the heat-sealing properties.

A beverage such as boiling water or cold water is poured into a paper cup, and therefore, it is demanded that a paper substrate does not absorb the beverage. It cannot be said that the aqueous dispersions of Patent Literatures 1 and 2 have sufficient water-resistance. When a paper cup is coated with each of the aqueous dispersions, the substrate of the paper cup may absorb a beverage.

Further, an aqueous coating agent with which a paper substrate is coated also requires heat-resistance in consideration of a line for manufacturing a paper cup. In a common line for manufacturing a paper cup, a paper substrate coated with an aqueous coating agent comes into contact with a metal plate, and the paper substrate coming into contact with the metal plate is continuously processed to manufacture a paper cup.

In the line for manufacturing a paper cup, the metal plate is often heated by heat generated when the paper substrate is processed. Accordingly, a reduction in friction between the paper substrate and the heated metal plate is required in the aqueous coating agent. In Patent Literature 1 and 2, the heat-resistance of the aqueous dispersions is not taken into consideration, and it is not clear whether the aqueous dispersions of both literatures can be used in a line for continuously manufacturing a paper cup.

As described above, an aqueous coating agent requires various performances in the food field. The aqueous coating agent should be excellent not only in heat-sealing properties, water-resistance, and heat-resistance but also in common performance such as coating properties. In consideration of storage-stability, the aqueous coating agent requires dispersion-stability such as inhibition of the precipitation of a dispersoid when being an emulsion.

The present invention was made for solving the above-described problems, with an objective to provide an aqueous coating agent having a heat-sealing property, water-resistance, heat-resistance, and storage-stability. Moreover, an objective of the present invention is to provide a paper substrate coated with the coating agent.

### Solution to Problem

As a result of repeating diligent study, the present inventors found that an aqueous coating agent excellent in water-resistance, heat-resistance, a heat-sealing property, and storage-stability is obtained by blending a specific ethylene-based copolymer, a basic material, and particles having a specific melting point, and the present invention was thus accomplished.

The present specification comprises the following embodiments.

1. An aqueous coating agent comprising: (A) a copolymer of ethylene with a carboxylic acid derivative having an ethylenic double bond; (B) a basic material; and (C) particles having a melting point of 100° C. or more.

2. The aqueous coating agent according to 1, wherein the component (C) is comprised in an amount of 1 to 20 parts by mass based on 100 parts by mass of the total of the components (A), (B), and (C).

3. The aqueous coating agent according to 1 or 2, wherein (A) the copolymer of ethylene with a carboxylic acid derivative having an ethylenic double bond comprises a copolymer of ethylene with (meth)acrylic acid.

4. The aqueous coating agent according to any one of 1 to 3, wherein (C) the particles having a melting point of 100° C. or more comprise an aqueous dispersion of a paraffin-based resin.

5. The aqueous coating agent according to any one of 1 to 3, wherein (C) the particles having a melting point of 100° C. or more comprise a starch.

6. The aqueous coating agent according to 5, wherein the starch comprises tapioca.

7. The aqueous coating agent according to any one of 1 to 6, wherein the aqueous coating agent further comprises (D) a polyvinyl alcohol derivative.

8. The aqueous coating agent according to any one of 1 to 7, wherein (D) the polyvinyl alcohol derivative comprises at least one selected from polyvinyl alcohols and ethylene-modified polyvinyl alcohols.

9. A paper substrate which is coated with the aqueous coating agent according to any one of 1 to 8.

10. A paper product comprising the paper substrate according to 9.

### Advantageous Effects of Invention

The aqueous coating agent of the present invention is excellent in water-resistance, heat-resistance, a heat-sealing property, and storage-stability, and is particularly effective in coating a paper substrate.

The paper substrate of the present invention is coated with the coating agent described above, and is therefore resistant to water and heat, and suitable for processing a food packaging container such as a paper cup, or paper-made straws.

### DESCRIPTION OF EMBODIMENTS

The aqueous coating agent (also simply referred to as “coating agent”) of the present invention comprises: (A) a copolymer of ethylene with a carboxylic acid derivative having an ethylenic double bond (also referred to as “component (A)” or “(A) copolymer”); (B) a basic material (also referred to as “component (B)”); and (C) particles having a melting point of 100° C. or more (also referred to as “(C) particles”).

Herein, the “aqueous coating agent” refers to a coating agent in which polymer particles and/or the like can be dispersed or dissolved in an aqueous medium, and is preferably an emulsion in which polymer particles and/or the like are dispersed in an aqueous medium.

The “aqueous medium” refers to common water such as city water, distilled water, or ion-exchanged water, may comprise an organic solvent that is soluble or dispersible in water and has poor reactivity with a raw material of resin related to the present invention such as a monomer, for example, acetone, ethyl acetate, or the like, may further comprise a monomer, oligomer, prepolymer, resin, and/or the like soluble or dispersible in water, and may comprise an emulsifier, polymerizable emulsifier, polymerization reaction initiator, chain extender, various additives, and/or the like commonly used when an aqueous resin or water-soluble resin is produced, as described later.

The aqueous coating agent of the present embodiment is excellent in water-resistance, a heat-sealing property, heat-resistance, and storage-stability. Each component is described below.

<(A) Copolymer of Ethylene with Carboxylic Acid Derivative Having Ethylenic Double Bond>

In an embodiment of the present invention, the “(A) copolymer of ethylene with a carboxylic acid derivative having an ethylenic double bond” (hereinafter also referred to as the “(A) copolymer” or “component (A)”) is a copolymer of ethylene with a carboxylic acid derivative having an ethylenic double bond, and the copolymer is not particularly limited as long as the aqueous coating agent to which the present invention is directed can be obtained.

The aqueous coating agent of the present invention comprises the component (A), whereby the aqueous coating agent of the embodiment of the present invention becomes excellent in water-resistance, a heat-sealing property, and storage-stability (dispersion-stability).

Herein, the “carboxylic acid derivative having an ethylenic double bond” refers to a carboxylic acid derivative (comprising carboxylic acid) having a double bond between carbon atoms that enables addition polymerization with ethylene, and specifically refers to a “carboxylic acid having an ethylenic double bond”, a “carboxylic acid anhydride having an ethylenic double bond”, a “carboxylate ester having an ethylenic double bond”, a “carboxylate salt having an ethylenic double bond”, or the like.

The “carboxylic acid having an ethylenic double bond” is a compound having an ethylenic double bond and a carboxyl group, and the compound is not particularly limited as long as the aqueous coating agent to which the present invention is directed can be obtained. Specific examples thereof may comprise oleic acid, linolic acid, maleic acid, itaconic acid, acrylic acid, and methacrylic acid.

The “carboxylic acid anhydride having an ethylenic double bond” refers to a compound obtained by dehydration condensation of two molecules of carboxylic acid or a compound obtained by dehydrating two carboxyl groups in one molecule, and the compound is not particularly limited as long as the aqueous coating agent to which the present invention is directed can be obtained. Specifically, examples thereof may comprise fumaric anhydride and maleic anhydride.

Examples of the “carboxylate ester having an ethylenic double bond” may comprise: (meth)acrylate esters such as methyl (meth)acrylate, ethyl (meth)acrylate, butyl (meth)acrylate, and 2-ethylhexyl (meth)acrylate; vinyl carboxylates and allyl esters such as vinyl acetate and allyl acetate.

Herein, the (meth)acrylate esters represent both of acrylate esters and methacrylate esters.

In the embodiment of the present invention, the “carboxylate ester having an ethylenic double bond” preferably comprises a (meth)acrylate ester such as methyl (meth)acrylate, ethyl (meth)acrylate, butyl (meth)acrylate, and 2-ethylhexyl (meth)acrylate, more preferably comprises methyl (meth)acrylate, ethyl (meth)acrylate, or butyl (meth)acrylate, and particularly desirably comprises methyl methacrylate or ethyl acrylate.

The “carboxylate salt having an ethylenic double bond” is not particularly limited as long as the aqueous coating agent to which the present invention is desired can be obtained. Specific examples thereof may comprise sodium (meth)acrylate and potassium (meth)acrylate.

Herein, examples of the “(A) copolymer of ethylene with a carboxylic acid derivative having an ethylenic double bond” may comprise:
a copolymer of ethylene with a carboxylic acid having an ethylenic double bond (also referred to as “ethylene/carboxylic acid copolymer”);
a copolymer of ethylene with a carboxylic acid anhydride having an ethylenic double bond (also referred to as “ethylene/carboxylic acid anhydride copolymer”);
a copolymer of ethylene with a carboxylate ester having an ethylenic double bond (also referred to as “ethylene/carboxylate ester copolymer”); and
a copolymer of ethylene with a carboxylate salt having an ethylenic double bond (also referred to as “ethylene/carboxylate salt copolymer”).

Examples of the ethylene/carboxylic acid copolymer may comprise a copolymer of ethylene with (meth)acrylic acid (ethylene/(meth)acrylic acid copolymer) and a copolymer of ethylene with itaconic acid (ethylene/itaconic acid copolymer),
examples of the ethylene/carboxylic acid anhydride copolymer may comprise a copolymer of ethylene with maleic anhydride (ethylene/maleic anhydride copolymer),
examples of the ethylene/carboxylate ester copolymer may comprise: a copolymer of ethylene with (meth)acrylate ester (ethylene/(meth)acrylate ester copolymer); a copolymer of ethylene with vinyl carboxylate (ethylene/vinyl carboxylate copolymer); and a copolymer of ethylene with allyl carboxylate (ethylene/allyl carboxylate copolymer), and
examples of the ethylene/carboxylate salt copolymer may comprise a copolymer of ethylene with sodium (meth)acrylate (ethylene/sodium (meth)acrylate copolymer) and a copolymer of ethylene with potassium (meth)acrylate (ethylene/potassium (meth)acrylate copolymer).

In the embodiment of the present invention, (A) the copolymer preferably comprises a “copolymer of ethylene with a (meth)acrylic acid derivative”. The “copolymer of ethylene with a (meth)acrylic acid derivative” preferably comprises at least one selected from ethylene/(meth)acrylic acid copolymers, ethylene/(meth)acrylic anhydride copolymers, ethylene/(meth)acrylate ester copolymers, and ethylene/(meth)acrylate salt copolymers, and most desirably comprises an ethylene/(meth)acrylic acid copolymer.

The (A) copolymer comprises ethylene/(meth)acrylic acid copolymer”, whereby the water-resistance and heat-sealing property of the aqueous coating agent of the embodiment of the present invention are considerably improved.

The (A) copolymer is mixed with a component (B) and a component (C) described later in a state in which the (A) copolymer is dispersed in an aqueous medium.

In the embodiment of the present invention, the (A) copolymer preferably comprises at least one selected from a copolymer of ethylene with a carboxylic acid having an ethylenic double bond and a copolymer of ethylene with a carboxylate salt having an ethylenic double bond, and more preferably comprises at least one selected from a copolymer of ethylene with a carboxylic acid having an ethylenic double bond and a carboxylate ester having an ethylenic double bond and a copolymer of ethylene with a carboxylate salt having an ethylenic double bond and a carboxylate ester having an ethylenic double bond.

In the embodiment of the present invention, the (A) copolymer is preferably dispersed in an aqueous medium. The melting point of the (A) copolymer is preferably less than 100° C., still more preferably 50 to 90° C., and particularly preferably 60 to 90° C. The melting point is most preferably 70 to 90° C. When the (A) copolymer is dispersed in an aqueous medium, the melting point of the (A) copolymer refers to the melting point of the copolymer comprising no aqueous medium.

### <(B) Basic Material>

Herein, the (B) basic material refers to a material which is dissolved in water to thereby have a pH more than 7, and the material is not particularly limited as long as the compatibility of each component comprised in an aqueous coating agent can be improved, the (A) copolymer can be neutralized, and the aqueous coating agent to which the present invention is directed is obtained.

Here, “neutralization” can be usually performed by adding the (B) basic material which is used for neutralization. As a result, when the (A) copolymer has an anionic group, for example, when the (A) copolymer particularly has a carboxyl group, the (A) copolymer can be neutralized to impart the (A) copolymer with water solubility to some extent. However, it is not necessary that the (A) copolymer is completely soluble in water. The (A) copolymer may have water solubility with such a degree that the characteristic of the aqueous coating agent of the embodiment of the present invention is not deteriorated.

The form of the basic material may be any of gas, liquid, and solid forms as long as the aqueous coating agent to which the present invention is directed is obtained. The basic material is preferably an aqueous solution form in which it dissolves in water because the basic material is easily handled and neutralization reaction is easily controlled. Examples of such “basic material” may comprise ammonia, alkali metals such as sodium and potassium, or alkali earth metals such as calcium and magnesium, aqueous ammonia, an aqueous sodium solution (aqueous sodium hydroxide solution), or an aqueous potassium solution (aqueous potassium hydroxide solution) is preferred.

The (B) basic material is preferably added so that the pH of an aqueous medium comprising the (A) copolymer is 8.0 or more, more preferably added so that the pH is 8.0 to 10.0, and particularly preferably added so that the pH is 8.0 to 9.5.

The aqueous coating agent of the embodiment of the present invention comprises the (B) basic material, whereby the compatibility of each component is improved, the (A) copolymer is neutralized to further enhance compatibility with another component, and the balance of water-resistance, a heat-sealing property, heat-resistance, and storage-stability becomes excellent.

### <(C) Particles Having Melting Point of 100° C. or More>

The (C) particles of the embodiment of the present invention are mixed with the component (A) and the component (B) in a state in which the particles are dispersed in an aqueous medium, the particles can be mixed with other components described later, the particles have a melting point of 100° C. or more, and the (C) particles are not particularly limited as long as and the aqueous coating agent to which the present invention is directed is obtained.

Herein, “granular” means a state in which solid grains are gathered, and “particles” mean the aggregate itself of grains.

The particles are selected from organic particles and inorganic particles, and preferably selected from the organic particles, and the organic particles preferably comprise at least one kind of carbohydrate particles and resin particles.

However, the component (C) comprises neither the component (A) nor a component (D).

Examples of the particles comprise, but are not limited to, the powders of carbohydrates such as wheat flours and starches, and the particles of organic substances such as resins of colloids and the like dispersed in solvents, paraffin-based resins, and olefinic resins.

The melting point of the (C) particles is 100° C. or more, and preferably 100° C. to 300° C.

The melting point of the component (C) is the melting point of the particles themselves, but does not mean the melting point of particles comprising an aqueous medium.

The aqueous coating agent of the embodiment of the present invention comprises the component (C), whereby water-resistance can be further improved.

Herein, the melting point refers to a value measured using differential scanning calorimetric measurement (DSC). Specifically, 10 mg of a sample was weighed in an aluminum container, the melting peak was measured at a temperature-raising rate of 10° C./min using DSC6220 (trade name) manufactured by SII NanoTechnology Inc. The temperature of the melting peak top refers to a melting point.

The above description of the melting point applies not only to the melting point of the component (C) but also to the melting point of another component.

The (C) particles are preferably carbohydrate powders and the particles of resins such as paraffin-based resins and olefin-based (or olefinic) resins, and more preferably aqueous dispersions of paraffin-based resins, aqueous dispersions of olefin-based resins, and starches. The aqueous dispersions of paraffin-based resins and the aqueous dispersions of olefin-based resins are different from wax.

Herein, “wax” is regarded as an organic substance which is a solid at ordinary temperature and becomes a liquid at less than 100° C. when the substance is heated. In other words, the melting point of wax is less than 100° C., and therefore, wax does not correspond to the component (C) having a melting point of 100° C. or more.

Paraffin is one of hydrocarbon compounds (organic compounds), is the generic name of an aliphatic chain type saturated hydrocarbon, is also referred to as an alkane, and is represented by CₙH₂ₙ₊₂. Olefin is the generic name of an aliphatic chain type unsaturated hydrocarbon having one double bond, and is represented by CₙH₂ₙ. In addition, n in each chemical formula is a natural number. Both of the paraffin-based resins and the olefin-based resins corresponding to the (C) particles have melting points of 100° C. or more.

A dispersion in which particles based on a resin related to paraffin or olefin (the chemical formula described above) are dispersed in an aqueous medium is the aqueous dispersion of the paraffin-based resin and the aqueous dispersion of the olefin-based resin.

Examples of the starches comprise: natural starches such as corn starches, tapioca starches, potato starches, sweet potato starches, wheat starches, and rice starches, having melting points of 100° C. or more; and processed starches such as etherified starches, esterified starches, cross-linked starches, grafted starches, oxidized starches, acid-decomposed starches, dextrin, obtained by processing the natural starches.

The aqueous coating agent of the embodiment of the present invention particularly preferably comprises an aqueous dispersion of a paraffin-based resin and/or a tapioca starch.

When the component (C) comprises the aqueous dispersion of the paraffin-based resin, the aqueous coating agent of the embodiment of the present invention is superior in balance of water-resistance and a heat-sealing property.

When the component (C) comprises the tapioca starch, the aqueous coating agent of the embodiment of the present invention is improved in heat-resistance, the friction between a paper substrate and a heated metal plate is reduced in the case of continuously producing a paper cup, and therefore, a paper cup can be efficiently and safely produced.

In the aqueous coating agent of the embodiment of the present invention, the component (C) is preferably comprised in an amount of 1 to 20 parts by mass, particularly preferably in an amount of 2 to 18 parts by mass, and most desirably in an amount of 3 to 15 parts by mass, based on 100 parts by mass of the total of the components (A), (B), and (C).

When the amount of the comprised component (C) is in the range described above, the aqueous coating agent of the embodiment of the present invention is superior in the balance of water-resistance, a heat-sealing property, heat-resistance, and dispersion-stability.

Specific examples of the component (C) comprise:
aqueous dispersions of synthetic resins, such as EMUSTER-6315 (trade name) and EMUSTER-1309 (trade name) from NIPPON SEIRO CO., LTD., and CHEMIPEARL W308 (trade name) from Mitsui Chemicals, Inc.;
aqueous dispersions of natural resins, such as XEM-1515 (trade name) from NIPPON SEIRO CO., LTD., and Hi-Mic-2095 (trade name) from Yamakei; and
tapioca starches such as Z300F (trade name) from NIPPON STARCH CHEMICAL CO., LTD.

### <(D) Polyvinyl Alcohol Derivative>

The aqueous coating agent of the embodiment of the present invention preferably comprises a (D) polyvinyl alcohol derivative as well as the components (A) to (C). The aqueous coating agent comprises the component (D), whereby the stability of a dispersoid is improved, precipitation of particles in an aqueous medium is inhibited, and storage-stability can be improved.

Examples of the (D) polyvinyl alcohol derivative of the embodiment of the present invention may comprise polyvinyl alcohols and polyvinyl alcohol-modified products.

The “polyvinyl alcohol” is commonly produced by hydrolyzing polyvinyl acetate, and can comprise an acetate ester group (CH₃COO⁻).

Herein, the “polyvinyl alcohol-modified product” refers to a polyvinyl alcohol modified by adding a new functional group (preferably hydrophilic group). A polyvinyl alcohol can be modified to produce a modified polyvinyl alcohol by adding a new functional group during or after synthesis of the polyvinyl alcohol.

Examples of the polyvinyl alcohol-modified product comprise ethylene-modified polyvinyl alcohols, butenediol-modified polyvinyl alcohols, sulfonic acid-modified polyvinyl alcohols, acetoacetyl group-modified polyvinyl alcohols, carboxylic acid-modified polyvinyl alcohols, and amino group-modified polyvinyl alcohols.

With regard to the aqueous coating agent of the embodiment of the present invention, the component (D) comprises a polyvinyl alcohol or an ethylene-modified polyvinyl alcohol, whereby more homogeneous dispersion of the components (A) to (C) in an aqueous medium is facilitated, and storage-stability (dispersion-stability) is further improved.

The coating agent for a paper substrate of the embodiment of the present invention comprises the components (A) to (C), optionally comprises the component (D), and may further comprise a viscosity adjuster, a plasticizer, an antifoaming agent, an antiseptic agent, a coloring agent, or the like as an additive.

Examples of the viscosity adjuster may comprise urea, urea compounds, nitrogen-containing materials such as dicyandiamide, calcium hydroxide, calcium oxide, sodium carbonate, trisodium phosphate, diammonium hydrogen phosphate, borax, sodium fluoride, and water glass.

Examples of the plasticizer may comprise: glycerin; polyhydric alcohols such as ethylene glycol and propylene glycol; and organic solvents such as cellosolves.

Examples of the antifoaming agent may comprise:
silicone-based antifoaming agents such as dimethylpolysiloxane, polyoxyalkylene-modified silicone, organic modified polysiloxane, and fluorine silicone;
antifoaming agents based on oils and fats such as castor oil, sesame oil, linseed oil, and animal and vegetable oils;
antifoaming agents based on fatty acids such as stearic acid, oleic acid, and palmitic acid;
antifoaming agents based on fatty acid esters such as Isoamyl stearate, diglycol laurate, distearyl succinate, distearate, sorbitan monolaurate, glycerin fatty acid ester, polyoxyethylene sorbitate, butyl monolaurate stearate, sucrose fatty acid ester, ethylacetic acid alkyl ester of sulfonated ricinate, and natural wax;
alcohol-based antifoaming agent such as polyoxyalkylene glycol and derivatives thereof, polyoxyalkylene alcohol hydrate, diamylphenoxyethanol, 3-heptanol, and 2-ethylhexanol;
ether-based antifoaming agents such as 3-heptylcellosolve and nonylcellosolve-3-heptylcarbitol;
antifoaming agents based on phosphate esters such as tributylphosphate, sodium octyl phosphate, and tris(butoxyethyl)phosphate;
amine-based antifoaming agents such as diamylamine;
amide-based antifoaming agents such as polyalkylene amide, acylate polyamine, and dioctadecanoyl piperidine;
antifoaming agents based on metal soaps such as aluminum stearate, calcium stearate, potassium oleate, and calcium salts of wool olein; and
antifoaming agents based on sulfonic acid esters such as sodium lauryl sulfonate and sodium dodecyl sulfonate.

These additives may be blended after preparation of the aqueous coating agent, may be blended with a monomer which is a raw material of the (A) copolymer, or may be added to a coating agent in an emulsion form (mixture of components (A) and (B), or mixture of components (A) and (C)).

The aqueous coating agent of the present embodiment can be produced by mixing another component as well as the components (A) to (D), and may be heated in mixing. The order of adding each component, a heating method, a stirring method, and the like are not particularly limited, and known methods can be used.

A surface of a paper substrate utilized in a food packaging container, a paper cup, or the like can be coated with the aqueous coating agent of the present invention. A coating film formed from the aqueous coating agent of the present invention is excellent in water-resistance, a heat-sealing property, and heat-resistance, and further excellent in storage-stability (dispersion-stability).

A surface of a paper substrate is directly coated with the aqueous coating agent of the present invention, and the aqueous coating agent can be used as a one-liquid type coating agent and as a top coating agent of a two-liquid type coating agent.

A usual coating method may be used as a method of coating a paper substrate with the aqueous coating agent of the present invention. For example, a paper substrate is coated with the coating agent of the present invention by using a known coater such as a table coater, a bar coater, a two-roll size press coater, a gate roll coater, a blade metaling coater, a rod metaling coater, a blade coater, an air knife coater, a roll coater, a brush coater, a kiss coater, a squeeze coater, a curtain coater, a die coater, a gravure coater, or a dip coater.

An amount of the aqueous coating agent with which a paper substrate is coated is not particularly limited, but is, for example, preferably 5 to 100 g/m², more preferably 5 to 50 g/m², and particularly preferably 10 to 20 g/m² as a solid content (dry mass). Here, the solid content of the coating agent refers to a solid content obtained by drying the coating agent at 105° C. for 3 hours.

One aspect of the present invention relates to a paper substrate of which a surface is coated with the aqueous coating agent described above. The paper substrate of the present invention is excellent in water-resistance, a heat-sealing property, and heat-resistance, and can be preferably utilized in a paper product such as a food packaging container or a paper cup.

One aspect of the present invention relates to a paper substrate having the aqueous coating agent described above. The paper substrate is not particularly limited, and known paper or synthetic paper obtained by making a chemical pulp such as broadleaf tree kraft pulp or coniferous tree kraft pulp, a mechanical pulp such as GP (ground-wood pulp), RGP (refiner ground pulp), or TMP (thermomechanical pulp), or the like can be used as the paper substrate. Moreover, premium grade paper, medium grade paper, alkaline paper, glassine paper, semi-glassine paper, or paperboard or white paperboard for use in corrugated fiberboard, a building material, white lined chipboard, chipboard, or the like can be used as the paper substrate described above. An organic or inorganic pigment, or a paper-making auxiliary agent such as a paper strong agent, a sizing agent, or a yield improver may be comprised in the paper substrate.

One aspect of the present invention relates to a paper product having a paper substrate of which a surface is coated with the aqueous coating agent described above. The paper product of an embodiment of the present invention is also excellent in water-resistance, and can be utilized in a paper-made straw, toilet paper, a paper cup, or the like. The paper product of the present invention has the paper substrate described above, and can be therefore utilized in various applications without deteriorating oil resistance and water-resistance even if the shape thereof is bent. In particular, the paper product is preferable for food packaging and a beverage container (paper cup).

### EXAMPLES

The present invention is specifically described below in detail with reference to Examples and Comparative Examples. Each of these Examples is merely one embodiment of the present invention, and the present invention is not limited at all to these Examples.

A numerical value related to an amount of each of blended components (A) to (D) described in Tables 1 to 4 represents part(s) of “solid content excluding solvent (material excluding water)”, and the unit thereof is part(s) by mass. The total amount of the components (A) to (C) is converted into 100 parts by mass, and the part(s) by mass of each component are set forth in Tables 1 to 4.

The details of the components (A) to (D) used in Examples 1 to 22 and Comparative Examples 1 to 6 are described below.
(A) Copolymer of ethylene with carboxylic acid derivative having ethylenic double bond
(A1) Copolymer of ethylene with acrylic acid (melting point of 77° C., trade name: Primacor 5980 (SK Geo Centric Japan))
(A2) Copolymer of ethylene with methacrylic acid (melting point of 84° C., trade name: NUCREL 2050H (DOW-MITSUI POLYCHEMICALS CO., LTD.))
(A3) Copolymer of ethylene with methacrylate salt (melting point of 83° C., trade name: SURLYNPC2000 (manufactured by DOW-MITSUI POLYCHEMICALS CO., LTD.))
(A′4) Copolymer of styrene with acrylic acid (trade name: JONCRYL 679 (Johnson Polymer))
(A′5) Ethylenehomopolymer (trade name: NP105 (Mitsui Chemicals, Inc.)
(B) Basic material
(B1) 25% Aqueous ammonia solution
(B2) 50% Aqueous sodium hydroxide solution
(C) Particles having melting point of 100° C. or more
(C1) Aqueous dispersion of paraffin-based resin (melting point of 103° C., trade name: XEM-1515, manufactured by NIPPON SEIRO CO., LTD.)
(C2) Aqueous dispersion of olefin-based resin (melting point of 130° C., trade name: CHEMIPEARL W308, manufactured by Mitsui Chemicals, Inc.)
(C3) Tapioca starch (trade name: Z300F, melting point of 253° C., manufactured by NIPPON STARCH CHEMICAL CO., LTD.)
(C′4) Carnauba wax emulsion (melting point of 87° C., trade name: AQUACER 581, manufactured by BASF)
(C′5) Paraffin wax emulsion (melting point of 77° C., trade name: XEM-2131L, manufactured by NIPPON SEIRO CO., LTD.)
(D) Polyvinyl alcohol derivative
(D1) Polyvinyl alcohol (trade name: JP33 (manufactured by JAPAN VAM & POVAL CO., LTD.) polymerization degree of 3300)
(D2) Polyvinyl alcohol (trade name: JP18 (manufactured by JAPAN VAM & POVAL CO., LTD.) polymerization degree of 1800)
(D3) Polyvinyl alcohol (trade name: JP10 (manufactured by JAPAN VAM & POVAL CO., LTD.) polymerization degree of 1000)
(D4) Polyvinyl alcohol (trade name: JF17 (manufactured by JAPAN VAM & POVAL CO., LTD.) polymerization degree of 1700)
(D5) Ethylene-modified polyvinyl alcohol (trade name: EXCEVAL R S1717 manufactured by Kuraray Co., Ltd.))

### <Preparation of Aqueous Coating Agent and Production of Coating Paper>

### Example 1

(A1) 400 g of a copolymer of ethylene with acrylic acid (trade name: Primacor 5980 (manufactured by SK Geo Centric Japan)), (B1) 40 g of 25% aqueous ammonia solution, (B2) 12 g of 50% aqueous sodium hydroxide solution, and 920 g of water were loaded in a separable flask of 2000 mL in capacity including an agitating blade having a diameter of 150 mm.

The water acts as an aqueous dispersion medium in which each component is dispersed. The contents in the flask were heated under agitation, and the temperature thereof was increased. The internal temperature of the separable flask was increased to 92° C., the agitation was continued for 2 hours at the temperature, and the contents were then cooled to room temperature while continuing the agitation. (C1) 80 g of an aqueous dispersion of a paraffin-based resin (trade name: XEM-1515, manufactured by NIPPON SEIRO CO., LTD.) was added to obtain an aqueous coating agent of Example 1.

The amount of each blended component, described with regard to the step of preparing an aqueous coating agent, is a weight in an actual product, and may also comprise both the weight of a solid content and the weight of a solvent.

However, the amount of each of the blended components (A) to (D) set forth in Tables 1 to 4 is part(s) by weight of the solid content excluding the solvent. However, the amount of blended water set forth in Tables 1 to 4 means the total of water comprised in the aqueous coating agent (including water added together with the components), and comprises neither a solid content nor a solvent except water.

White premium grade paper (manufactured by Chuetsu Pulp & Paper Co., Ltd., basis weight of 104.7 g/m², thickness of 126 μm, opacity of 94%) was coated with the aqueous coating agent of Example 1 by a bar coater. The amount of coating was adjusted by the bar coater so that the amount of the coating after the drying of the aqueous coating agent was 10 g/m². After the coating, the premium grade paper was put in a drying machine at 130° C. to obtain coating paper (test body) of Example 1.

### Example 2

(D1) 4 g of polyvinyl alcohol (trade name: JP33 (manufactured by JAPAN VAM & POVAL CO., LTD.) was loaded together with the components (A1), (B1), and (B2) used in Example 1 in a separable flask, the contents were heated under agitation to increase the temperature thereof, and the agitation was continued at the temperature for 2 hours. Then, the contents were cooled to room temperature while continuing the agitation, and the component (C1) was added to obtain an aqueous coating agent of Example 2.

The aqueous coating agent of Example 2 was prepared by a method similar to that in Example 1 except that the component (D1) was blended, and the aqueous coating agent was used to obtain coating paper of Example 2. The composition of the aqueous coating agent of Example 2 is indicted in Table 1.

### Examples 3 to 21 and Comparative Examples 1 to 6

Each component was blended by a method similar to that in Example 2, to produce aqueous coating agents of Examples 3 to 21 and Comparative Examples 1 to 6. The compositions of the aqueous coating agents are as indicated in Tables 1 to 3.

Like Example 2, the amount of each of the blended components (A) to (D) set forth in Table 1 represents part(s) by mass of a solid content excluding a solvent, and the amount of blended water does not comprise the solid content. The compositions of the aqueous coating agents of Examples 3 to 21 and Comparative Examples 1 to 6 are indicated in Table 1.

White premium grade paper was coated with each of the aqueous coating agent of Examples 3 to 21 and Comparative Examples 1 to 6 by a bar coater, and coating paper (test body) of each of Examples 3 to 21 and Comparative Examples 1 to 6 was produced by a method similar to that in Example 2.

### Example 22

Each component was blended by a method similar to that in Example 2 to prepare an aqueous coating agent of Example 22, and coating paper (test body) of Example 22 was produced by a method similar to that in Example 2. The composition of the aqueous coating agent of Example 22 is indicated in Table 4.

Then, the surface of the coating paper (test body) was further coated with the aqueous coating agent to produce “coating paper (two-coating type)” coated with the aqueous coating agent twice.

The amount of each of blended components (A) to (D) indicated in Table 4 represents the part(s) by mass of a solid content excluding a solvent, and the amount of blended water does not comprise the solid content.

As indicated in Tables 1 to 4, the water-resistance, heat-sealing property, heat-resistance (heating friction coefficient), and storage-stability (dispersion-stability) of the aqueous coating agent were evaluated with regard to the coating paper of each of these Examples and Comparative Examples.

The details of evaluation tests are as follows.

### <Water-Resistance Test (Measurement of Amount of Water Absorption at High Temperature)>

The coating paper (test body) was cut in a circular shape having a diameter of 10 cm, the mass thereof was measured, the upper and lower portions of the test body were then sandwiched with circular cylindrical flasks of which the upper portion having an inner diameter of 7 cm was open (or released), and the test body was left to stand for 30 minutes in a state in which 50 ml of warm water at 90° C. was dropwise added from above.

Then, the water was taken out, the test body was removed from the circular cylinders, and the mass thereof was measured in a state in which water droplets were removed from the surfaces of the test body. A variation in the mass of the test body before and after the test was calculated, an increment thereof was regarded as the amount of water absorption, and the amount of water absorption per unit area was calculated.

The criteria of evaluation are as follows.

Excellent: The amount of water absorption is less than 10 g/m², and water-resistance is kept.

Good: The amount of water absorption is 10 g/m² or more and less than 20 g/m², and water-resistance is kept.

Fair: The amount of water absorption is 20 g/m² or more and less than 50 g/m², and water-resistance is kept.

Poor: The amount of water absorption is 50 g/m² or more, and water-resistance is not kept.

### <Water-Resistance Test (Measurement of Amount of Water Absorption at Room Temperature)>

The coating paper (or test body) was cut in a circular shape having a diameter of 10 cm, the mass thereof was measured, the upper and lower portions of the test body were then sandwiched with circular cylindrical flasks of which the upper portion having an inner diameter of 7 cm was open, and the test body was left to stand for 30 minutes in a state in which 50 mL of distilled water at 23° C. was dropwise added from above.

Then, the water was taken out, the test body was removed from the circular cylinders, and the mass thereof was measured in a state in which water droplets were removed from the surfaces of the test body. A variation in the mass of the coating paper before and after the test was calculated, an increment thereof was regarded as the amount of water absorption, and the amount of water absorption per unit area was calculated.

The criteria of evaluation are as follows.

Excellent: The amount of water absorption is less than 10 g/m², and water-resistance is kept.

Good: The amount of water absorption is 10 g/m² or more and less than 20 g/m², and water-resistance is kept.

Fair: The amount of water absorption is 20 g/m² or more and less than 50 g/m², and water-resistance is kept.

Poor: The amount of water absorption is 50 g/m² or more, and water-resistance is not kept.

### <Heat-Sealing Property Test>

The coating paper (or test body) was cut in a size of 25 mm×100 mm. The coating surfaces of the test bodies were stacked (or faced each other) and set in a pressing machine of which the upper portion was warmed to 130° C., and pressed at a pressure of 0.6 MPa for 0.6 second. The test bodies were set at room temperature for 2 hours, peel strength was measured by TENSILON, and a peeled portion was visually observed, and evaluated.

The criteria of the evaluation are as follows.

Excellent: The substrate is subjected to material failure (in peeling, breakage of the coating paper was observed).

Good: Interfacial peeling (peeling in interface between the premium grade paper and the coating) occurs, and peel strength is 15 gf/25 mm or more.

Fair: Interfacial peeling occurs, and peel strength is less than 15 gf/25 mm.

Poor: Adhesion (sealing) does not occur.

### <Heat-Resistance Test (Measurement of Static Friction Coefficient)>

Heat-resistance was evaluated by measuring a static friction coefficient.

The static friction coefficient refers to the ratio between friction force generated on the contact faces of two objects and force acting in a direction perpendicular to the contact faces in a static friction state, that is, in a state in which relative motion does not occur.

For the measurement of the static friction coefficient, a static friction coefficient between a coating paper surface and an SUS (stainless steel) plate heated to 60° C. was measured using a stand for measuring a load MX2-500N (manufactured by IMADA CO., LTD.) and a digital force gauge ZTA-50N (manufactured by IMADA CO., LTD.).

A commercially available SUS (stainless steel) plate (dimension of 25 mm×25 mm) heated to 60° C. was used as an opposite material rubbed together with the coating paper (or test piece).

The SUS (stainless steel) plate was brought into contact with the test piece at a normal load of 600 g, and the static friction coefficient in the case of rubbing together with a movable table, to which the test piece was attached, at a movement rate (test rate) of 120 mm/min was then determined.

The criteria of evaluation are as follows.

Excellent: A static friction coefficient is less than 0.5.

Good: A static friction coefficient is 0.5 or more and less than 1.0.

Fair: A static friction coefficient is 1.0 or more and less than 2.0.

Poor: A static friction coefficient is 2.0 or more.

### <Storage-Stability Test (Dispersion-Stability)>

The aqueous coating agent was put in a glass beaker of 300 mL and left to stand at 23° C. for 1 day, and the phase separation state of the aqueous coating agent was then observed.

The criteria of evaluation are as follows.

Excellent: Neither gelation nor phase separation occurred.

Good: Gelation did not occur, but phase separation partially occurred.

Poor: Gelation and phase separation occurred.

TABLE 1

| | | Example | | | | | | | | |
|---|---|---|---|---|---|---|---|---|---|---|
| | | 1 | 2 | 3 | 4 | 5 | 6 | 7 | 8 | 9 |
| (A) | (A1) | 89.2 | 89.2 | | 88.5 | 87.3 | 84.0 | 90.1 | 89.2 | 89.2 |
| | (A2) | | | 89.2 | | | | | | |
| | (A3) | | | | | | | | | |
| | (A′4) | | | | | | | | | |
| | (A′5) | | | | | | | | | |
| (B) | (B1) | 2.2 | 2.2 | 2.2 | 1.3 | 0.9 | 0.4 | 2.7 | 2.2 | 2.2 |
| | (B2) | 1.3 | 1.3 | 1.3 | 3.0 | 4.8 | 8.8 | | 1.3 | 1.3 |
| (C) | (C1) | 7.1 | 7.1 | 7.1 | 7.0 | 7.0 | 6.6 | 7.2 | 7.1 | 7.1 |
| | (C2) | | | | | | | | | |
| | (C3) | | | | | | | | | |
| | (C′4) | | | | | | | | | |
| | (C′5) | | | | | | | | | |
| (D) | (D1) | | 0.9 | 0.9 | 0.9 | 0.9 | 0.8 | 0.8 | | |
| | (D2) | | | | | | | | 0.9 | |
| | (D3) | | | | | | | | | 0.9 |
| | (D4) | | | | | | | | | |
| | (D5) | | | | | | | | | |
| | Water | 215 | 216 | 216 | 205 | 204 | 199 | 200 | 216 | 216 |
| Total | | 100 | 100 | 100 | 100 | 100 | 100 | 100 | 100 | 100 |

| | | | | | | | | | |
|---|---|---|---|---|---|---|---|---|---|
| Water-resistance | Excel- | Excel- | Excel- | Good | Good | Fair | Excel- | Excel- | Good |
| (high temperature) | lent | lent | lent | | | | lent | lent | |
| Water-resistance | Excel- | Excel- | Excel- | Excel- | Excel- | Good | Excel- | Excel- | Good |
| (room temperature) | lent | lent | lent | lent | lent | | lent | lent | |
| Heat-sealing | Good | Excel- | Excel- | Excel- | Excel- | Excel- | Excel- | Excel- | Excel- |
| property | | lent | lent | lent | lent | lent | lent | lent | lent |
| Heat-resistance | Good | Good | Good | Good | Good | Good | Good | Good | Good |
| Storage-stability | Good | Excel- | Excel- | Excel- | Excel- | Excel- | Excel- | Excel- | Excel- |

| | | | | | | | |
|---|---|---|---|---|---|---|---|
| lent | lent | lent | lent | lent | lent | lent | lent |

TABLE 2

| | | Example | | | | | | | | |
|---|---|---|---|---|---|---|---|---|---|---|
| | | 10 | 11 | 12 | 13 | 14 | 15 | 16 | 17 | 18 |
| (A) | (A1) | 89.2 | 89.2 | 88.4 | 93.0 | | 89.2 | 89.2 | 95.1 | 94.0 |
| | (A2) | | | | | | | | | |
| | (A3) | | | | | 85.3 | | | | |
| | (A′4) | | | | | | | | | |
| | (A′5) | | | | | | | | | |
| (B) | (B1) | 2.2 | 2.2 | 2.2 | 2.3 | 0.2 | 2.2 | 2.2 | 2.4 | 2.3 |
| | (B2) | 1.3 | 1.3 | 1.3 | 1.4 | | 1.3 | 1.3 | 1.4 | 1.4 |
| (C) | (C1) | 7.1 | 7.1 | | | 6.8 | 7.1 | | 1.1 | 2.2 |
| | (C2) | | | | | | | 7.1 | | |
| | (C3) | | | 8.0 | 3.0 | 7.7 | | | | |
| | (C′4) | | | | | | | | | |
| | (C′5) | | | | | | | | | |
| (D) | (D1) | | | 0.9 | 0.8 | 0.8 | | 0.8 | 0.8 | 0.8 |
| | (D2) | | | | | | | | | |
| | (D3) | | 1.8 | | | | | | | |
| | (D4) | 0.9 | | | | | | | | |
| | (D5) | | | | | | 0.9 | | | |
| | Water | 216 | 216 | 214 | 210 | 188 | 216 | 216 | 230 | 227 |
| Total | | 100 | 100 | 100 | 100 | 100 | 100 | 100 | 100 | 100 |

| Evaluation | | | | | | | | | |
|---|---|---|---|---|---|---|---|---|---|
| Water-resistance | Good | Good | Good | Good | Fair | Excel- | Excel- | Good | Good |
| (high temperature) | | | | | | lent | lent | | |
| Water-resistance | Good | Good | Good | Good | Good | Good | Excel- | Good | Good |
| (room temperature) | | | | | | | lent | | |
| Heat-sealing | Excel- | Excel- | Good | Excel- | Excel- | Excel- | Excel- | Excel- | Excel- |
| property | lent | lent | | lent | lent | lent | lent | lent | lent |
| Heat-resistance | Good | Good | Excel- | Excel- | Excel- | Good | Good | Good | Good |
| | | | lent | lent | lent | | | | |
| Storage-stability | Excel- | Excel- | Excel- | Excel- | Excel- | Excel- | Excel- | Excel- | Excel- |
| | lent | lent | lent | lent | lent | lent | lent | lent | lent |

TABLE 3

| | | Example | | | Comparative Example | | | | | |
|---|---|---|---|---|---|---|---|---|---|---|
| | | 19 | 20 | 21 | 1 | 2 | 3 | 4 | 5 | 6 |
| (A) | (A1) | 91.9 | 87.7 | 78.7 | 96.1 | 192.6 | | 89.2 | 89.2 | |
| | (A2) | | | | | | | | | |
| | (A3) | | | | | | | | | |
| | (A′4) | | | | | | 89.2 | | | |
| | (A′5) | | | | | | | | | 89.2 |
| (B) | (B1) | 2.3 | 2.2 | 1.9 | 2.4 | | 2.2 | 2.2 | 2.2 | 2.1 |
| | (B2) | 1.4 | 1.3 | 1.1 | 1.4 | | 1.3 | 1.3 | 1.3 | 1.2 |
| (C) | (C1) | 4.4 | 8.7 | 7.8 | | 7.4 | 7.1 | | | 7.1 |
| | (C2) | | | | | | | | | |
| | (C3) | | | 10.2 | | | | | | |
| | (C′4) | | | | | | | | 7.1 | |
| | (C′5) | | | | | | | 7.1 | | |
| (D) | (D1) | 0.8 | 0.8 | 0.8 | 0.8 | 0.8 | 0.8 | 0.8 | 0.8 | 0.8 |
| | (D2) | | | | | | | | | |
| | (D3) | | | | | | | | | |
| | (D4) | | | | | | | | | |
| | (D5) | | | | | | | | | |
| | Water | 223 | 211 | 210 | 234 | 224 | 219 | 219 | 220 | |
| Total | | 100 | 100 | 100 | 100 | 100 | 100 | 100 | 100 | 100 |

| Evaluation | | | | | | | | | |
|---|---|---|---|---|---|---|---|---|---|
| Water-resistance | Good | Excel- | Excel- | Poor | Poor | Poor | Poor | Poor | Poor |
| (high temperature) | | lent | lent | | | | | | |
| Water-resistance | Excel- | Excel- | Excel- | Good | Poor | Poor | Fair | Fair | Poor |
| (room temperature) | lent | lent | lent | | | | | | |
| Heat-sealing | Excel- | Excel- | Good | Good | Poor | Poor | Good | Good | Poor |
| property | lent | lent | | | | | | | |
| Heat-resistance | Good | Good | Excel- | Fair | Poor | Good | Fair | Fair | Good |
| | | | lent | | | | | | |
| Storage-stability | Excel- | Excel- | Excel- | Good | Poor | Good | Good | Good | Poor |
| | lent | lent | lent | | | | | | |

TABLE 4

| | | Example |
|---|---|---|
| | | 22 |
| (A) | (A1) | 82.6 |
| | (A2) | |
| | (A3) | |
| | (A′4) | |
| | (A′5) | |
| (B) | (B1) | 2.1 |
| | (B2) | 1.2 |
| (C) | (C1) | 6.6 |
| | (C2) | |
| | (C3) | 7.4 |
| | (C′4) | |
| | (C′5) | |
| (D) | (D1) | 0.8 |
| | (D2) | |
| | (D3) | |
| | (D4) | |
| | (D5) | |
| | Water | 200 |
| Total | | 100 |

| | |
|---|---|
| Evaluation | |
| Water-resistance | Good |
| (high temperature) | |
| Water-resistance | Excellent |
| (room temperature) | |
| Heat-sealing property | Excellent |
| Heat-resistance | Excellent |
| Storage-stability | Excellent |
| Two-coating | |
| Water-resistance | Good |
| (high temperature) | |
| Water-resistance | Excellent |
| (room temperature) | |
| Heat-sealing property | Excellent |

As set forth in Tables 1 to 3, it was demonstrated that the aqueous coating agents of Examples 1 to 21 comprise the components (A) to (C) and are therefore excellent in water-resistance, heat-sealing properties, heat-resistance, and storage-stability (dispersion-stability).

Like Example 22 disclosed in Table 4, a paper substrate can also be coated twice with the aqueous coating agent of the embodiment of the present invention.

In contrast, each of the aqueous coating agents of Comparative Examples 1 to 6 does not comprise any of the components (A) to (C), and is therefore poor in water-resistance.

Further, the aqueous coating agent of Comparative Example 2 does not comprise the (B) basic material, and therefore, the (A) polymer is not neutralized, and the components (A) to (C) are not homogeneously dispersed in an aqueous medium. Thus, all of the water-resistance, heat-sealing property, heat-resistance (static friction coefficient), and dispersion-stability of the aqueous coating agent of Comparative Example 2 are considerably degraded.

The aqueous coating agent of each of Comparative Examples 3 and 6 does not comprise the (A) copolymer of ethylene with a carboxylic acid derivative, and not only the water-resistance but also heat-sealing property of the aqueous coating agent deteriorates.

### INDUSTRIAL APPLICABILITY

In the present invention, an aqueous coating agent with which a paper surface is coated can be provided. A surface of the paper substrate is coated with the coating agent of the embodiment of the present invention to produce a paper product. Examples of the paper product comprise food packaging containers, paper cups, and paper-made straws.

### CROSS-REFERENCE TO RELATED APPLICATION

This application claims priority under Article 4 of the Paris Convention based on Japanese Patent Application No. 2023-106958 filed on Jun. 29, 2023 in Japan. This priority patent application is incorporated herein by reference in its entirety.

1: An aqueous coating agent comprising: (A) a copolymer of ethylene with a carboxylic acid derivative having an ethylenic double bond; (B) a basic material; and (C) particles having a melting point of 100° C. or more.

2: The aqueous coating agent according to claim 1, wherein the component (C) is comprised in an amount of 1 to 20 parts by mass based on 100 parts by mass of the total of the components (A), (B), and (C).

3: The aqueous coating agent according to claim 1, wherein (A) the copolymer of ethylene with a carboxylic acid derivative having an ethylenic double bond comprises a copolymer of ethylene with (meth)acrylic acid.

4: The aqueous coating agent according to claim 1, wherein (C) the particles having a melting point of 100° C. or more comprise an aqueous dispersion of a paraffin-based resin.

5: The aqueous coating agent according to claim 1, wherein (C) the particles having a melting point of 100° C. or more comprise a starch.

6: The aqueous coating agent according to claim 5, wherein the starch comprises tapioca.

7: The aqueous coating agent according to claim 1, wherein the aqueous coating agent further comprises (D) a polyvinyl alcohol derivative.

8: The aqueous coating agent according to claim 1, wherein (D) the polyvinyl alcohol derivative comprises at least one selected from polyvinyl alcohols and ethylene-modified polyvinyl alcohols.

9: A paper substrate which is coated with the aqueous coating agent according to claim 1.

10: A paper product comprising the paper substrate according to claim 9.
